(19) United States
(12) Patent Application Publication
(10) Pub. No.: US 2014/0005352 A1
(43) Pub. Date: Jan. 2, 2014

(54) GAS SCRUBBER AND RELATED PROCESSES

(71) Applicant: INVISTA NORTH AMERICA S.A R.L., Wilmington, DE (US)

(72) Inventors: Clive Alexander HAMILTON, Swainby (GB); Robert Edward Neate, Guisborough (GB)

(21) Appl. No.: 13/804,958

(22) Filed: Mar. 14, 2013

Related U.S. Application Data
(60) Provisional application No. 61/666,455, filed on Jun. 29, 2012.

(51) Int. Cl. C08G 63/78

(52) U.S. Cl. CPC C08G 63/785
USPC 528/305; 423/245.1; 422/209; 422/129; 422/131

(57) ABSTRACT

The invention relates to a method for producing a high molecular weight polyethylene terephthalate (PET) via a solid state polymerization system. The method comprises using an acid catalyst to effectuate the conversion of acetaldehyde present within the system to 2-methyl-1,3-dioxolane, which can be readily removed. The invention also relates to PET prepared via this process, which can advantageously exhibit low levels of acetaldehyde.

### FIELD OF THE INVENTION

The invention is related to methods for purifying a contaminated process gas. It is also related to systems implementing such methods, and PET made from such methods and systems.

### BACKGROUND OF THE INVENTION

Polyester resins such as poly(ethylene terephthalate) (PET) resins are widely produced and used, for example, in beverage and food containers, thermoforming applications, textiles, and engineering resins. Generally, the production of PET is based on a reaction between terephthalic acid and/or dimethyl terephthalate with ethylene glycol (via esterification and/or transesterification, respectively). The resulting bis-hydroxyethyl terepthalate pre-polymers are then joined by means of polycondensation reactions to give a polymeric product.

Melt polycondensation alone is generally not capable of producing polyesters such as bottle-grade PET resin with the desired properties. Therefore, a two-stage process is generally employed, wherein the pre-polymers are subjected to melt polycondensation to achieve a certain intrinsic viscosity; subsequently, the resin is subjected to a process known as “solid state polycondensation” (“SSP”). The SSP process is specifically designed for the development of higher molecular weight polymeric products having increased intrinsic viscosities. The SSP process results in further increasing the molecular weight of the melt-polymerized PET by polycondensation of the polymer chains with each other.

Various byproducts can be produced during the production of PET, including, but not limited to, polycondensation cleavage products. One common side reaction that may occur during the polycondensation reaction is the production of acetaldehyde (AA) by transesterification of vinyl ester end groups of the PET. The presence of AA is often of significant importance in PET production and its content is rigorously controlled for certain uses. As an example, when PET is used to produce bottles as containers for beverages, AA in the bottle can migrate to the beverage, causing an undesirable flavor in the beverage (which is particularly noticeable in water). It is therefore desirable to minimize the content of AA in the final PET product.

Generally during the SSP process, reaction byproducts such as AA are removed via a process gas that is at least partially re-circulated through the system. The process gas takes up impurities (e.g., reaction byproducts) from the system and the impurity-rich gas is subsequently purified to remove those impurities and render the gas available for reuse in the system. Various means are known for purifying process gases. One common gas purification system utilizes a gas scrubber containing an aqueous or organic fluid that is brought into contact with the impurity-rich gas and which purifies the gas via a liquid-gas exchange process.

### BRIEF SUMMARY OF THE INVENTION

Advantageously, ethylene glycol can be used as the washing fluid in such a scrubber. Because ethylene glycol is a starting material for PET production, the “dirty” ethylene glycol can, in some instances, be recycled for use within a PET melt polycondensation production system. It would be advantageous to provide an additional method for purifying a process gas for use within the SSP process and for controlling the acetaldehyde levels of the resulting PET resin.

The inventors have found that acetaldehyde (AA) (as may be present in the process gas circulating within a solid state polycondensation (SSP) system for the production of polyethylene terepthalate (PET)) and ethylene glycol (EG) (as may be present as a washing liquid in a gas scrubber for the process gas) reversibly react to form 2-methyl-1,3-dioxolane (“MDO”) and water. Advantageously, according to the present invention, a catalyst can be incorporated within the gas scrubber to facilitate this reaction to form MDO. The conversion of AA to MDO is beneficial as it effectively results in removal of AA from the system. Although not intended to be limiting, certain potential benefits can be obtained in certain embodiments: 1) the “dirty” ethylene glycol can be used in further PET preparation processes and, with decreased AA content, reduces contamination of the subsequently produced PET with AA; 2) the limit on AA content in the resin introduced to the SSP process can be increased (i.e., the specifications on the input material can be loosened); and 3) smaller, more efficiently designed scrubbers may be utilized.

In one aspect of the invention is provided a method for removing impurities from a process gas, comprising: introducing a process gas inlet stream comprising a first concentration of acetaldehyde into a gas scrubbing unit; introducing an ethylene glycol inlet stream into the gas scrubbing unit; contacting the process gas inlet stream with the ethylene glycol inlet stream in the presence of one or more acid catalysts in the gas scrubbing unit, wherein the acetaldehyde reacts with the ethylene glycol to form 2-methyl-1,3-dioxolane during said contacting step, the contacting step producing a purified process gas stream comprising a second concentration of acetaldehyde lower than the first concentration and an ethylene glycol outlet stream containing 2-methyl-1,3-dioxolane; and removing the purified process gas stream and the ethylene glycol outlet stream from the gas scrubbing unit.

In another aspect of the invention is provided a method of preparing a high molecular weight polymer, comprising: passing a polymer having a first intrinsic viscosity through one or more reactors to provide a polymer having a second intrinsic viscosity that is higher than the first intrinsic viscosity; passing a process gas through the one or more reactors, wherein the process gas adsorbs acetaldehyde, and bringing the process gas into fluid communication with a gas scrubbing unit according to the method described above.

In yet another aspect of the invention is provided a polyester manufactured according to the methods described above.

In some embodiments, the process gas is selected from the group consisting of nitrogen, argon, carbon dioxide, and mixtures thereof. In some embodiments, the method can further comprise recycling and/or using the purified process gas stream, for example, as a process gas stream in a further method of preparing a high molecular weight polymer.

The acid catalysts used in the method can vary and can be, in certain embodiments, homogeneous or heterogeneous acid catalysts. For example, the acid catalysts can be selected from the group consisting of mineral acids, sulfonic acids, carboxylic acids, and mixtures thereof. In some specific embodiments, the one or more acid catalysts are selected from the group consisting of a boron trihalide, an organoborane, an aluminum trihalide, methanesulfonic acid, ethanesulfonic acid, benzenesulfonic acid, p-toluene sulfonic acid, trifluoromethanesulfonic acid, a boric acid, hydrochloric acid, hydroiodic acid, hydrobromic acid, perchloric acid, nitric acid, sulfuric acid, fluorosulfuric acid, oxalic acid, acetic acid, phosphoric acid, citric acid, carbonic acid, formic acid, benzoic acid, and mixtures and derivatives thereof. In certain embodiments, the one or more acid catalysts comprise a solid support having an acidic functionality attached thereto, wherein the acidic functionality is selected from the group consisting of a boron trihalide, an organoborane, an aluminum trihalide, methanesulfonic acid, ethanesulfonic acid, benzenesulfonic acid, p-toluene sulfonic acid, trifluoromethanesulfonic acid, a boric acid, hydrochloric acid, hydroiodic acid, hydrobromic acid, perchloric acid, nitric acid, sulfuric acid, fluorosulfuric acid, oxalic acid, acetic acid, phosphoric acid, citric acid, carbonic acid, formic acid, benzoic acid, and mixtures and derivatives thereof.

In certain embodiments, the temperature at which the contacting step is conducted is about 50° C. or less. The method can comprise various additional steps; for example, in some embodiments, the method can further comprise cleaning the ethylene glycol after the purifying step. The cleaning step can, in certain embodiments, comprise neutralizing the ethylene glycol, filtering the ethylene glycol, distilling the ethylene glycol, or a combination thereof. In further embodiments, the ethylene glycol outlet stream may be used as a reactant in to produce poly(ethylene terephthalate) via melt condensation polymerization.

In some embodiments, the method of preparing a high molecular weight polymer utilizes a polymer having a first intrinsic viscosity with an acetaldehyde content of about 10 ppm or more or about 50 ppm or more. In some embodiment, the method produces a polymer having a second intrinsic viscosity and having an acetaldehyde content of about 1 ppm or less.

In another aspect of the invention is provided a gas scrubbing apparatus comprising: a housing enclosing a chamber adapted to provide contact between a process gas and a scrubbing liquid, the chamber containing one or more solid acid catalysts; a supply of process gas comprising acetaldehyde; a first inlet in fluid communication with the chamber and in fluid communication with the supply of process gas comprising acetaldehyde and adapted to introducing the process gas comprising acetaldehyde into the chamber; a supply of ethylene glycol; a second inlet in fluid communication with the chamber and in fluid communication with the supply of ethylene glycol and adapted to introducing the ethylene glycol into the chamber; a first outlet in fluid communication with the chamber and adapted to remove an ethylene glycol stream containing 2-methyl-1,3-dioxolane from the chamber; and a second outlet in fluid communication with the chamber and adapted to remove a purified process gas stream from the chamber.

In certain embodiments, the one or more acid catalysts are heterogeneous acid catalysts, present in a packed tray within the gas scrubbing unit. The operation of the gas scrubbing apparatus can vary and may comprise, for example, a centrifugal-type scrubber, spray scrubber, impingement-type scrubber, packed tower-based scrubber, venturi-type scrubber, eductor venturi-type scrubber, film tower-based scrubber, scrubber with rotating elements, or a combination thereof.

In a further aspect of the invention is provided a system for the production of high molecular weight polymer, comprising one or more reactors adapted to receive a polymer having a first intrinsic viscosity and to produce a polymer having a second intrinsic viscosity that is higher than the first intrinsic viscosity, wherein the one or more reactors are adapted to receive a supply of process gas and wherein the supply of process gas is in fluid communication with the gas scrubbing apparatus described above.

### BRIEF DESCRIPTION OF THE DRAWING

Having thus described the invention in general terms, reference will now be made to the accompanying drawing, which is not necessarily drawn to scale, and wherein:

FIG. 1 is a depiction of an exemplary gas scrubber according to the invention; and

FIG. 2 is a depiction of an exemplary SSP system according to the invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise.

Briefly, the present invention provides a method for manufacturing a high molecular weight polyester from a solidified polyester pre-polymer via solid state polycondensation (SSP), wherein polycondensation cleavage products are removed from the product by means of a process gas, which is subsequently purified to remove such undesirable cleavage products. According to the invention, purification of the process gas is facilitated by means of a washing liquid in the presence of an acid catalyst, wherein the acid catalyst functions to convert one or more of the cleavage products to an alternate compound which can be more readily removed from the SSP system. Further, the invention provides an apparatus for manufacturing a high molecular weight polyester that includes at least one crystallization unit and a reaction unit, wherein each unit has product inlets and outlets and process gas inlets and outlets. According to the invention, the apparatus further comprises a gas purification system (e.g., a gas scrubber unit) equipped to receive the process gas and a washing fluid and bring the gas and fluid into contact with one another, wherein the gas purification system also contains one or more acid catalysts.

In particular, the SSP process is commonly used to produce high molecular weight polyethylene terephthalate (PET), which is known to produce acetaldehyde (AA) as an undesirable byproduct. The AA content in the final PET resin produced via SSP is advantageously minimized, as AA can subsequently leach out of PET, and has been noted to negatively impact the taste of beverages and/or foods contained in PET containers. The inventors have found that AA present in the process gas can reversibly react with EG present in the gas scrubber to form 2-methyl-1,3-dioxolane (“MDO”) and water. According to one aspect of the disclosed processes, one or more acid catalysts are incorporated within the gas scrubber to promote and/or enhance this reaction of AA and EG to form MDO, and thereby reduce the AA present in the system. It is noted that, although the present disclosure focuses on methods and systems for the production of PET, it may be applicable to the production of other polymers, such as other polyesters, as well. In particular, it may be applicable to the production of various polymers wherein AA is produced as an undesirable reaction byproduct.

By converting the AA to MDO, the SSP gas can be provided in a cleaner form (i.e., with decreased AA content), such that it can be more readily re-used in the SSP process. Using this cleaner SSP gas may effectively reduce AA contamination in the PET preparation process and thereby reduce the AA content of the subsequently produced PET. Additionally, by converting the AA to MDO, the limit on AA content in the PET resin introduced to the SSP process can be increased (i.e., the specifications on the input material can be loosened), as the process may, in certain embodiments, be capable of more effectively decreasing the AA content throughout the SSP process. Further, by converting the AA to MDO, it may be possible to provide smaller, more efficiently designed scrubbers for use in the SSP system.

By “promoting” or “enhancing” the conversion of AA to MDO is meant that a greater percentage of AA is converted to MDO than would occur in the absence of an acid catalyst. For example, a catalyst can, in some embodiments, increase the rate of and/or percent conversion of AA to MDO. In some embodiments, a catalyst can shift the equilibrium of a reversible reaction to the product side. Although not intending to be limited by theory, it is believed that protonation of the carbonyl oxygen of AA by an acid catalyst may promote nucleophilic attack by a hydroxyl group on the EG at the carbonyl carbon of AA, driving the conversion to MDO.

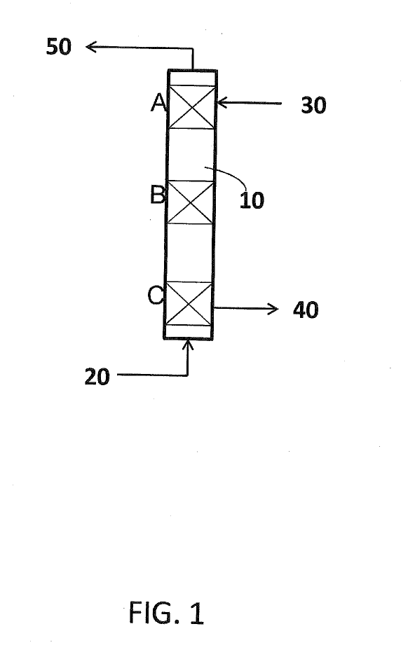

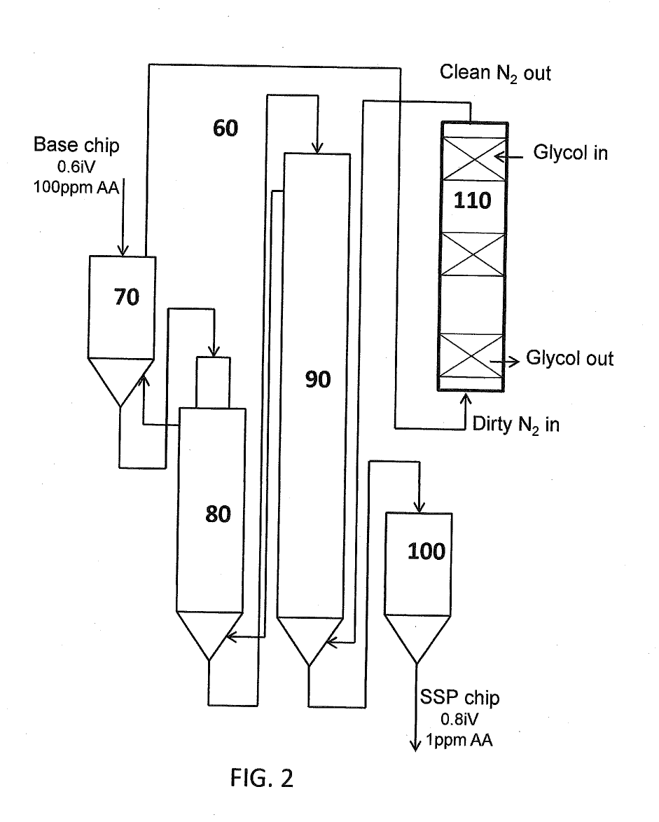

The means by which catalysis of the conversion of EG to MDO is effected by an acid catalyst according to the present invention can vary. In certain embodiments, a catalyst is incorporated within a gas scrubber unit. FIG. 1 provides a schematic depiction of a gas scrubber 10. Although FIG. 1 depicts a general gas scrubber setup, it is to be understood that a variety of gas scrubbers are known in the art and can be modified for use according to the present invention. Scrubbers can vary widely in size, capacity, operation, and complexity, and all such types are intended to be encompassed by the disclosure provided herein. Generally, scrubbers are designed so as to bring a dirty process gas into intimate contact with a washing fluid that can remove certain contaminants therefrom (e.g., by adsorption). Certain scrubbers operate by means of directing dirty process gas through a tortuous path (e.g., using baffles and other restrictions) and/or provide for some degree of turbulence to ensure significant contact with a washing fluid, wherein contaminants are removed by contact between the gas and the washing fluid. The washing fluid may be flowed, e.g., concurrently to the process gas within the scrubber or counter-currently to the process gas within the scrubber (as shown in FIGS. 1 and 2), although the scrubber may operate in other ways. Scrubbers may be, for example, centrifugal-type scrubbers, spray scrubbers, impingement-type scrubbers, packed towers, venturi-type scrubbers, eductor venturi-type scrubbers, film towers, scrubbers with rotating elements, or scrubbers comprising multiple of these and other types. Although many types and design configurations of gas scrubbers are known and intended to be included within the present disclosure, exemplary types and design configurations are described for example, in U.S. Pat. Nos. 3,581,474 to Kent; 3,656,279 to Mcilvaine et al.; 3,680,282 to Kent; 3,690,044 to Boresta; 3,795,486 to Ekman; 3,870,484 to Berg; 5,185,016 to Carr; 5,656,047 to Odom et al.; 6,102,990 to Keinanen et al.; 6,402,816 to Trivet et al.; and U.S. Patent Application Publication Nos. 2007/0113737 to Hagg et al., which are incorporated herein by reference.

The gas scrubber unit shown in FIG. 1 is configured with a gas inlet, through which dirty process gas 20 (e.g., from the SSP process) enters the scrubber. It is noted that although the gas inlet is shown on the bottom of the scrubber, the dirty process gas may enter from the top or side of the scrubber. The dirty process gas generally comprises various byproducts of the polycondensation reaction, including, but not limited to, cleavage products such as water, ethylene glycol, methyl dioxolane, and aldehydes (e.g., acetaldehyde). The process gas cleaned via the scrubber (e.g., the process gas of the SSP system) can vary, but is generally a gas that is inert or relatively inert under the conditions within the system. For example, the process gas may, in some embodiments, comprise nitrogen, argon, helium, carbon dioxide, or mixtures thereof.

Within the gas scrubber, the dirty process gas comes into contact with the washing liquid. In certain embodiments, the washing liquid comprises ethylene glycol (EG). A clean EG supply 30 is in fluid contact with the gas scrubber and takes up certain impurities present in the dirty process gas, producing a “dirty” EG stream 40, comprising EG and byproducts of the polycondensation reaction present in the dirty process gas stream and a clean process gas stream 50.

According to the invention, various acid catalysts can be incorporated within the gas scrubber. Homogeneous acid catalysts, heterogeneous acid catalysts, or a combination thereof can be used. Acid catalysts that may be used according to the invention to promote the reaction of AA and EG to form MDO include, but are not limited to, Lewis acids and Brönsted acids. Acid catalysts may be, for example, mineral (i.e., inorganic) acids, sulfonic acids, or carboxylic acids. Certain specific acids include, but are not limited to, boron trihalides, organoboranes, aluminum trihalides, other various metal cations or compounds (which generally can serve as Lewis acids only after dissociating a Lewis base bound thereto); methanesulfonic acid, ethanesulfonic acid, benzenesulfonic acid, p-toluene sulfonic acid (TsOH), trifluoromethanesulfonic acid, boric acids, hydrochloric acid, hydroiodic acid, hydrobromic acid, perchloric acid, nitric acid, sulfuric acid, fluorosulfuric acid, oxalic acid, acetic acid, phosphoric acid, citric acid, carbonic acid, formic acid, and benzoic acid.

Although homogeneous acid catalysts may be effective in enhancing the conversion of AA and EG to MDO, in certain embodiments, one or more heterogeneous catalysts are used (generally in solid form). Heterogeneous acid catalysts generally comprise one or more acid functional groups immobilized on a solid support that is insoluble in the liquid or gas in which the reaction is to be conducted. Heterogeneous catalysts are advantageous in their ease of implementation, ease of removal, and the ability to maintain EG in neutral form. Various acidic functionalities can be provided on solid supports to provide the desired functionality in a solid form, such as those acidic moieities noted above. Various solid supports can be used as well, including, but not limited to, silica, clay, synthetic or natural polymers. Certain exemplary heterogeneous catalysts include Amberlyst™ polymeric catalysts and ion exchange resins, which generally display a sulfuric acid functional group. Other exemplary heterogeneous acid catalysts are described, for example, in U.S. Pat. Nos. 5,294,576 to Ho et al.; 5,481,0545, 563,313, 5,409,873, and 5,571,885 to Chung et al.; 5,663,470, 5,770,539, 5,877,371, and 5,874,380 to Chen et al.; and 6,436,866 to Nishikido, which are all incorporated herein by reference.

The reaction of AA and EG to form MDO has been observed to be temperature dependent if not catalyzed. For this reason, one would not expect significant reaction at typical temperatures within a gas scrubber. An exemplary scrubber may have a temperature of between about 5° C. and around 60° C., such as about 8° C. at the top, about 12° C. in the middle, and about 45° C. at the bottom of the scrubber. At ambient temperature, there is generally no appreciable reaction between AA and EG to produce MDO. At elevated temperatures, the reaction is enhanced. Beneficially, an added acidic catalyst allows for an efficient reaction of AA and EG to produce MDO at temperatures typically associated with a gas scrubber. Thus, the high temperatures generally required for reaction of AA and EG in the absence of an added catalyst to form MDO are not required and the methods of the invention can be readily implemented into existing scrubber systems with little to no modification or control of temperature within the scrubber.

It is noted that the reaction of AA and EG to form MDO is reversible and both the forward reaction and the reverse reaction are acid-catalyzed. It is preferred that, under the conditions of use, the reaction of AA and EG to form MDO is favored over the reverse reaction. The reverse reaction requires water; therefore, in some embodiments, it may be advantageous to limit the water content in the washing fluid. The latter (reverse) reaction is described in further detail, for example, in U.S. Patent Application Publication No. 2011/0097243 to Reimann et al., which is incorporated herein by reference.

The acidic catalyst can be incorporated within the gas scrubber in various ways. For example, as illustrated in FIG. 1, in some embodiments, the gas scrubber comprises a multi-stage setup (e.g., the 3-stage setup of FIG. 1, comprising stages A, B, and C). In such embodiments, a heterogeneous catalyst may be packed within a vessel (e.g., a packed tray/bed) held within the scrubber to provide one or more layers of material through which the ethylene glycol washing solution passes. With reference to FIG. 1, the catalyst may thus be provided in one or more of the three stages A, B, and C, depicted in scrubber 10 (i.e., at the top, middle, or bottom of the scrubber). It is noted that multi-stage scrubber units can have varying numbers of stages and the catalyst can be incorporated within any of these stages. The heterogeneous catalyst can be provided at varying levels within the scrubber; however, it is advantageously toward the bottom of the scrubber (i.e., a portion of the scrubber that is at a higher temperature, as increased temperature promotes the conversion of AA and EG to MDO). For example, with reference to FIG. 1, although the catalyst can be provided in any one or more of stages A, B, and C, catalyst may be provided, at least in part, in stage C. However, use of an acidic catalyst as described herein allows for the reaction to occur with good conversion of reactants to product, even at lower temperatures than generally required for such a reaction. Other physical means for ensuring contact between the acid catalyst and the dirty ethylene glycol are intended to be encompassed by the present invention as well. Where homogeneous catalysts are used, they may be, in some embodiments, directly added to the EG washing fluid. The amount of catalyst added to the gas scrubber system can vary, but may generally be any amount sufficient to catalyze the reaction of at least a portion, and including at least a substantial portion, of the AA with EG to produce MDO. Specifically, the amount of catalyst can vary from 1 kg per tonne per hour of EG scrubber liquid (1 kg/tph) to 1000 kg/tph; including 2 kg/tph to 100 kg/tph; 2 kg/tph to 10 kg/tph; and 5 kg/tph.

The gas scrubber as described herein is advantageously incorporated within an SSP system for polyester production, although application of the methods of the invention may be useful in other applications utilizing a gas scrubber wherein AA is beneficially minimized. The SSP system generally operates according to methods known in the art, as described for example, in U.S. Pat. No. 7,819,942 to Christel et al., which is incorporated herein by reference. FIG. 2 of the present application illustrates one exemplary SSP system 60, although the components within the system can vary. Briefly, the SSP process typically begins with the introduction of a substantially amorphous PET base chip, such as a base chip having an intrinsic viscosity of about 0.6 iV. The acetaldehyde content in the base chip can vary, but is advantageously reduced to or maintained at a low level through the SSP process. The base chip is crystallized to about 40 or 45% crystalline content in a crystallizer unit 70 by application of heat. The chip then typically passes through a preheater 80 and then can then be further heated in a reactor unit 90, which generally increases the crystallinity of the PET even further (e.g., to about 65-70% crystalline). It is within the reactor unit that the PET generally exhibits the greatest desirable buildup of intrinsic viscosity. The PET then passes into a cooler 100 to give an SSP PET chip having a higher intrinsic viscosity than the base chip (e.g., about 0.8 iV) and having a relatively low AA content (e.g., about 100 ppm or less, about 50 ppm or less, about 10 ppm or less, about 9 ppm or less, about 8 ppm or less, about 7 ppm or less, about 6 ppm or less, about 5 ppm or less, about 4 ppm or less, about 3 ppm or less, or about 2 ppm or less. In some embodiments, even lower AA values are obtainable, such as about 1 ppm or less. The reactor units within the SSP system can vary and may, in certain embodiments, include devices ranging from fixed-bed, solid-air jet, or fluidized bed reactors, and/or reactors having agitating implements or reactors that move. Various temperatures and pressures can be utilized in the various stages of the SSP process.

Also in FIG. 2 is illustrated the gas scrubber 110, as described in greater detail in reference to FIG. 1. FIG. 2 illustrates an exemplary flow system of the process gas, which then enters the gas scrubber (as “Dirty N₂ in”). Ethylene glycol, the washing fluid cycled through the gas scrubber, cleans the nitrogen process gas, providing it in “clean” form, at which point it can be subsequently reused (e.g., within the reactor 90, as shown in FIG. 2). The gas scrubber 110, according to the invention, further comprises an acid catalyst as provided herein. It is to be understood that FIG. 2 provides one exemplary system in which an acid catalyst can be used; this disclosure is not intended to be limiting, and the methods and materials described herein can be applied to various methods and systems wherein AA and EG may be present.

In certain embodiments, the dirty washing liquid (ethylene glycol) can be cleaned for reuse for various purposes. The EG can be cleaned, for example, by filtration and/or distillation. Use of a heterogeneous catalyst simplifies the cleanup of EG, as the EG generally is maintained in neutral form. Although homogeneous catalysts can be used according to the invention, their use generally results in the production of acidified glycol, which must be neutralized in addition to being filtered and/or distilled. The cleaned EG can beneficially be used, for example, as an input material for melt phase condensation polymerization to produce additional PET. Thus, in certain embodiments, a single EG stream may be used in the various steps in preparing high molecular weight PET. In such embodiments, EG recycled from the SSP process can be fed into a reaction with terephthalic acid and/or dimethyl terephthalate to give PET monomer units which are joined by melt phase condensation polymerization and which may be further subjected to SSP to increase the intrinsic viscosity thereof.

### EXPERIMENTAL

The reaction of acetaldehyde (AA) with ethylene glycol (EG) producing 2 methyl, 1,3 dioxolane (MDO) and water was carried out in glassware, under reflux, at atmospheric pressure as a function of temperature. The reaction was followed by extracting samples from the reaction zone via syringe as a function of time. Each sample was quenched in an isopropanol diluent and analyzed by gas chromatography (GC). Comparative examples 1, 2 and 3 illustrate the kinetics of the catalyst-free reaction monitored by following the formation of MDO and consumption of AA at 50° C., then separately at 85° C. and 130° C. Example 1 exemplifies the use of a solid acid catalyst, in this case Dow Amberlyst™ 35, at 50° C.

### Comparative Example 1

40 g of refrigerated acetaldehyde was added to 60 g of chilled ethylene glycol in a 250 ml round-bottomed flask and set up for reflux. The flask was heated to 50° C. and samples were extracted by syringe as a function of time and diluted tenfold in isopropanol to quench the reaction. The samples were analyzed by gas chromatography and the results tabulated below.

TABLE 1
AA and MDO concentrations at 50° C. as a function of time

| Elapsed time (min) | AA (%) | MDO (%) |
|---|---|---|
| 0 | — | — |
| 3 | 48.6 | 0.81 |
| 18 | 52.5 | 0.34 |
| 33 | 52.5 | 0.37 |
| 48 | 51.7 | 0.39 |
| 88 | 50.8 | 0.53 |
| 153 | 48.2 | 0.69 |
| 203 | 49.6 | 0.85 |
| 283 | 47.4 | 1.11 |
| 333 | 46 | 1.32 |
| 388 | 45.9 | 1.54 |
| 443 | 44.5 | 1.74 |
| 503 | 44.2 | 1.99 |

The data illustrates that at 50° C., the % AA decreases slowly and the % MDO rises slowly over the time period displayed.

### Comparative Example 2

20 g of refrigerated acetaldehyde was added to 80 g of chilled ethylene glycol in a 250 ml round-bottomed flask and set up for reflux. The flask was heated to 85° C. and samples were extracted by syringe as a function of time and diluted tenfold in isopropanol to quench the reaction. The samples were analyzed by gas chromatography and the results tabulated below.

TABLE 2
AA and MDO concentrations at 85° C. as a function of time

| Elapsed time (min) | AA (%) | MDO (%) |
|---|---|---|
| 0 | 29.0 | 0.24 |
| 10 | 19.3 | 1.87 |
| 20 | 11.8 | 4.84 |
| 30 | 9.6 | 7.91 |
| 60 | 7.0 | 14.92 |
| 125 | 5.15 | 22.88 |

The data illustrates that at 85° C., the % AA decreases more quickly and the % MDO rises more quickly over the time period displayed than at 50° C.

### Comparative Example 3

95 g of refrigerated acetaldehyde was added to 5 g of chilled ethylene glycol in a 250 ml round-bottomed flask and set up for reflux. The flask was heated to 130° C. and samples were extracted by syringe as a function of time and diluted tenfold in isopropanol to quench the reaction. The samples were analyzed by gas chromatography and the results tabulated below.

TABLE 3
AA and MDO concentrations at 130° C. as a function of time

| Elapsed time (min) | AA (%) | MDO (%) |
|---|---|---|
| 0 | — | — |
| 5 | 3.04 | 1.38 |
| 20 | 0.55 | 7.77 |
| 35 | 0.22 | 7.64 |
| 55 | 0.21 | 7.78 |
| 85 | 0.26 | 9.09 |
| 115 | 0.19 | 7.98 |

The data illustrates that at 130° C., the % AA decreases even more quickly and the % MDO rises even more quickly over the time period displayed than at 85° C.

### Example 1

40 g of refrigerated acetaldehyde was added to 60 g of chilled ethylene glycol in a 250 ml round-bottomed flask, set up for reflux, along with 2.5 g of Amberlyst™ 35 solid acid catalyst resin. The flask was heated to 50° C. and samples were extracted by syringe as a function of time and diluted tenfold in isopropanol to quench the reaction. The samples were analysed by gas chromatography and the results tabulated below.

TABLE 4
AA and MDO concentrations at 50° C. with added catalyst
as a function of time

| Elapsed time (min) | AA (%) | MDO (%) |
|---|---|---|
| 0 | 34.29 | 27.67 |
| 10 | 14.79 | 59.83 |
| 55 | 13.95 | 61.13 |
| 85 | 12.35 | 61.47 |
| 145 | 13.5 | 64.02 |

The data illustrates that at 50° C. with Amberlyst™ 35 solid acid catalyst resin added to the reaction, the % AA decreases more quickly and the % MDO rises even more quickly over the time period displayed than where no catalyst is added (Comparative Example 1).

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for removing impurities from a process gas, comprising:
introducing a process gas inlet stream comprising a first concentration of acetaldehyde into a gas scrubbing unit;
introducing an ethylene glycol inlet stream into the gas scrubbing unit;
contacting the process gas inlet stream with the ethylene glycol inlet stream in the presence of one or more acid catalysts in the gas scrubbing unit, wherein the acetaldehyde reacts with the ethylene glycol to form 2-methyl-1,3-dioxolane during said contacting step, the contacting step producing a purified process gas stream comprising a second concentration of acetaldehyde lower than the first concentration and an ethylene glycol outlet stream containing 2-methyl-1,3-dioxolane; and
removing the purified process gas stream and the ethylene glycol outlet stream from the gas scrubbing unit.

2. The method of claim 1, wherein the process gas is selected from the group consisting of nitrogen, argon, carbon dioxide, and mixtures thereof.

3. The method of claim 1, wherein the one or more acid catalysts are homogeneous or heterogeneous acid catalysts.

4. The method of claim 1, wherein the one or more acid catalysts are selected from the group consisting of mineral acids, sulfonic acids, carboxylic acids, and mixtures thereof.

5. The method of claim 1, wherein the one or more acid catalysts are selected from the group consisting of a boron trihalide, an organoborane, an aluminum trihalide, methanesulfonic acid, ethanesulfonic acid, benzenesulfonic acid, p-toluene sulfonic acid, trifluoromethanesulfonic acid, a boric acid, hydrochloric acid, hydroiodic acid, hydrobromic acid, perchloric acid, nitric acid, sulfuric acid, fluorosulfuric acid, oxalic acid, acetic acid, phosphoric acid, citric acid, carbonic acid, formic acid, benzoic acid, and mixtures and derivatives thereof.

6. The method of claim 1, wherein the one or more acid catalysts comprise a solid support having an acidic functionality attached thereto, wherein the acidic functionality is selected from the group consisting of a boron trihalide, an organoborane, an aluminum trihalide, methanesulfonic acid, ethanesulfonic acid, benzenesulfonic acid, p-toluene sulfonic acid, trifluoromethanesulfonic acid, a boric acid, hydrochloric acid, hydroiodic acid, hydrobromic acid, perchloric acid, nitric acid, sulfuric acid, fluorosulfuric acid, oxalic acid, acetic acid, phosphoric acid, citric acid, carbonic acid, formic acid, benzoic acid, and mixtures and derivatives thereof.

7. The method of claim 1, wherein the one or more solid catalysts is selected from the group consisting of Zirconia, alpha and gamma alumina, and zeolites.

8. The method of claim 1, wherein the temperature at which the contacting step is conducted is about 50° C. or less.

9. The method of claim 1, further comprising cleaning the ethylene glycol outlet stream after the purifying step.

10. The method of claim 9, wherein the cleaning comprises neutralizing the ethylene glycol outlet stream, filtering the ethylene glycol outlet stream, distilling the ethylene glycol outlet stream, or a combination thereof.

11. The method of claim 1, wherein the ethylene glycol outlet stream is used as a reactant in to produce poly(ethylene terepthalate) via melt condensation polymerization.

12. A method of preparing a high molecular weight polymer, comprising:
passing a polymer having a first intrinsic viscosity through one or more reactors to provide a polymer having a second intrinsic viscosity that is higher than the first intrinsic viscosity;
passing a process gas through the one or more reactors, wherein the process gas adsorbs acetaldehyde, and
bringing the process gas into fluid communication with a gas scrubbing unit according to the method of claim 1.

13. The method of claim 12, wherein the polymer is a polyester.

14. The method of claim 13, wherein the polyester is polyethylene terephthalate.

15. The method of claim 12, further comprising using the purified process gas stream as a process gas stream in a further method of preparing a high molecular weight polymer.

16. The method of claim 10, wherein the polymer having a second intrinsic viscosity has an acetaldehyde content of about 1 ppm or less.

17. The method of claim 12, wherein the polymer having a first intrinsic viscosity has an acetaldehyde content of about 10 ppm or more.

18. The method of claim 12, wherein the polymer having a first intrinsic viscosity has an acetaldehyde content of about 50 ppm or more.

19. A polyester manufactured according to any one of the methods of claims 12-18.

20. A gas scrubbing apparatus comprising:
a housing enclosing a chamber adapted to provide contact between a process gas and a scrubbing liquid, the chamber containing one or more solid acid catalysts;
a supply of process gas comprising acetaldehyde;
a first inlet in fluid communication with the chamber and in fluid communication with the supply of process gas comprising acetaldehyde and adapted to introducing the process gas comprising acetaldehyde into the chamber;
a supply of ethylene glycol;
a second inlet in fluid communication with the chamber and in fluid communication with the supply of ethylene glycol and adapted to introducing the ethylene glycol into the chamber;
a first outlet in fluid communication with the chamber and adapted to remove an ethylene glycol stream containing 2-methyl-1,3-dioxolane from the chamber; and
a second outlet in fluid communication with the chamber and adapted to remove a purified process gas stream from the chamber.

21. The gas scrubbing apparatus of claim 20, wherein the process gas is selected from the group consisting of nitrogen, argon, carbon dioxide, and mixtures thereof.

22. The gas scrubbing apparatus of claim 20, wherein the one or more acid catalysts are homogeneous or heterogeneous acid catalysts.
The gas scrubbing apparatus of claim 20, where the one or more acid catalysts are heterogeneous acid catalysts, present in a packed tray within the gas scrubbing unit.
The gas scrubbing apparatus of claim 20, wherein the one or more acid catalysts are selected from the group consisting of mineral acids, sulfonic acids, carboxylic acids, and mixtures thereof.

23. The gas scrubbing apparatus of claim 20, wherein the one or more acid catalysts are selected from the group consisting of a boron trihalide, an organoborane, an aluminum trihalide, methanesulfonic acid, ethanesulfonic acid, benzenesulfonic acid, p-toluene sulfonic acid, trifluoromethanesulfonic acid, a boric acid, hydrochloric acid, hydroiodic acid, hydrobromic acid, perchloric acid, nitric acid, sulfuric acid, fluorosulfuric acid, oxalic acid, acetic acid, phosphoric acid, citric acid, carbonic acid, formic acid, benzoic acid, and mixtures and derivatives thereof.

24. The gas scrubbing apparatus of claim 20, wherein the one or more acid catalysts comprise a solid support having an acidic functionality attached thereto, wherein the acidic functionality is selected from the group consisting of a boron trihalide, an organoborane, an aluminum trihalide, methanesulfonic acid, ethanesulfonic acid, benzenesulfonic acid, p-toluene sulfonic acid, trifluoromethanesulfonic acid, a boric acid, hydrochloric acid, hydroiodic acid, hydrobromic acid, perchloric acid, nitric acid, sulfuric acid, fluorosulfuric acid, oxalic acid, acetic acid, phosphoric acid, citric acid, carbonic acid, formic acid, benzoic acid, and mixtures and derivatives thereof.

25. The gas scrubbing apparatus of claim 20, wherein the one or more solid catalysts is selected from the group consisting of Zirconia, alpha and gamma alumina, and zeolites.

26. The gas scrubbing apparatus of claim 20, wherein the gas scrubbing unit comprises a centrifugal-type scrubber, spray scrubber, impingement-type scrubber, packed tower-based scrubber, venturi-type scrubber, eductor venturi-type scrubber, film tower-based scrubber, scrubber with rotating elements, or a combination thereof.

27. A system for the production of high molecular weight polymer, comprising one or more reactors adapted to receive a polymer having a first intrinsic viscosity and to produce a polymer having a second intrinsic viscosity that is higher than the first intrinsic viscosity, wherein the one or more reactors are adapted to receive a supply of process gas and wherein the supply of process gas is in fluid communication with the gas scrubbing apparatus of claim 20.

28. The system of claim 29, wherein the polymer is a polyester.

29. The system of claim 30, wherein the polyester is polyethylene terephthalate.

30. The method of one of claims 1-18, wherein the acid catalyst is present at a concentration between 1 kg/tph of ethylene glycol to 1000 kg/tph of ethylene glycol.

31. The method of claim 32, wherein the acid catalyst is present at a concentration between 2 kg/tph of ethylene glycol to 10 kg/tph of ethylene glycol.

32. The gas scrubbing apparatus of one of claims 20-28, wherein the acid catalyst is present at a concentration between 1 kg/tph of ethylene glycol to 1000 kg/tph of ethylene glycol.

33. The gas scrubbing apparatus of one of claim 34, wherein the acid catalyst is present at a concentration between 2 kg/tph of ethylene glycol to 10 kg/tph of ethylene glycol.
